(19) United States
(12) Patent Application Publication
(10) Pub. No.: US 2003/0079998 A1
(43) Pub. Date: May 1, 2003

(54) Automatic removal of mineral deposits from liquid

(75) Inventor: Mordechai Karin, Dn Merkaz (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: C.Q.M. LTD.

(21) Appl. No.: 09/984,242

(22) Filed: Oct. 29, 2001

(51) Int. Cl. C25C 3/16; C25B 9/00; B23H 7/14; C25F 7/00

(52) U.S. Cl. 205/687; 204/230.2; 204/275.1

(57) ABSTRACT

A device and method for removal of minerals from a supply of liquid such as water. The device includes a tank with an inner surface functioning as a first electrode, at least one inlet for liquid and at least one outlet to a system requiring liquid arranged such that entry and exit of liquid create a cyclonic flow, at least one second electrode within the tank placed so that the cyclonic flow of liquid passes between the two electrodes, and a mechanism for creating an electric current flowing between the two electrodes. The method includes the steps of causing a liquid to circulate cyclonically within a tank, applying an electric current to the circulating liquid so that minerals within the liquid precipitate on an inner surface of the tank, and reversing a polarity of the electric current in order to loosen the precipitated minerals from the inner surface of the tank.

### FIELD AND BACKGROUND OF THE INVENTION

The present invention relates to a device and method for the automatic removal of minerals from liquid supply systems and, more particularly, to a system of charged electrodes, which cause the precipitation of minerals within a tank, found within the system. After precipitation, minerals can be flushed from a lower portion of the tank via a valve, which is connected to a drainage pipe. This flushing process is aided by the mechanical action of a hydrocyclone within the tank. The present invention further relates to an automated regulatory mechanism which co-ordinates the flow of liquid into the tank, the supply of electricity to the electrodes and removal of mineral precipitates via a drainpipe.

A widespread problem in liquid based cooling systems, such as air conditioning systems, and in other systems in which large volumes of liquid flow, is accumulation of mineral deposits within pipes and cooling towers. These mineral deposits, primarily calcium based, reduce the efficiency of cooling towers, clog pipes, increase head pressure, decrease energy, prevent valves from properly closing and generally reduce the efficiency with which a liquid based system functions.

Pretreatment of liquid prior to introduction into a system has previously been accomplished by use of de-ionizing columns, chemically based liquid softeners, distillation, or reverse osmosis. While these methods are effective, they are costly and require on-going maintenance.

Electrolysis of liquid to precipitate minerals has previously not been a satisfactory solution for commercial applications owing to the large volumes of liquid to be treated and the local effect of the procedure. Specifically, electrolysis functions primarily on liquid located between an anode and a cathode, having little effect on mineral concentration in liquid located at a distance from the two electrodes. Previous electrolysis systems did not circulate the liquid through this active area between the electrodes.

Citation or identification of any reference in this section or in any other section of this application shall not be construed as an admission that such reference is available as prior art to the present invention.

There is thus a widely recognized need for, and it would be highly advantageous to have, a device and method for the automatic removal of minerals from liquid, which would operate economically. Such a device and method would increase the efficiency of cooling towers, prevent clogging of pipes, prevent increases in head pressure, prevent decreases in energy, facilitate proper valve closure and generally increase the efficiency with which a liquid based system functions. The present invention provides such a device and method by combining electrolysis with circulation of the liquid supply between electrodes.

### SUMMARY OF THE INVENTION

According to one aspect of the present invention there is provided a device for the automatic removal of minerals from a liquid supply, the device comprising: (a) a tank having an upper portion, a lower portion and an inner surface which functions as an electrode; (b) the upper portion of the tank containing at least one inlet for liquid and at least one outlet to a system requiring liquid, wherein the at least one inlet and at least one outlet are arranged such that entry and exit of liquid from the tank create a cyclonic flow; (c) at least one additional electrode located within the tank and being at a distance from the inner surface of the tank; and (d) a mechanism for creating an electric current flowing between the at least one additional electrode and the inner surface of the tank.

According to further features of preferred embodiments of the device of the present invention, there is provided a venturi mechanism, in communication with the lower portion of said tank.

According to additional further features of preferred embodiments of the device of the present invention, there is provided a drain valve, in communication the venturi mechanism

According to another aspect of the present invention there is provided a method for the automatic removal of minerals from liquid, the method comprising the steps of: (a) causing minerals to precipitate on an inner surface of a tank by applying an electric current to a supply of liquid circulating within the tank in a cyclonic fashion; (b) weakening the bond of the precipitated minerals to the inner surface of the tank by reversing the polarity of the electric current for a period of time; (c) removing the precipitated minerals from the tank via a drain after application of a physical force which frees the precipitated minerals from the inner surface of the tank.

According to yet another aspect of the present invention there is provided a method for removing mineral deposits from an inner surface of a tank, the method comprising the steps of: (a) weakening the bond of the mineral deposits to the inner surface of the tank by applying an electric current for a period of time, the electric current having the inner surface of the tank as its anode and at least one additional electrode within the tank as a cathode; (b) removing the mineral deposits from the inner surface of the tank by means of a hydrocyclone created by a flow of liquid through a venturi mechanism in fluid communication with the tank; and (c) causing the mineral deposits to exit the tank via a drain.

According to further features of preferred embodiments of the device of the present invention, there is included a regulatory mechanism controlling an electric current applied to the electrodes, the flow of liquid into the tank via the inlet, and the flow of liquid out of the tank via the outlet, the venturi mechanism and the drain valve.

According to further features in preferred embodiments of the invention described below, the device of the present invention includes a liquid conduit connecting the outlet from the tank to the venturi mechanism.

According to still further features in the described preferred embodiments the liquid conduit contains a one-way valve which allows the flow of liquid in that conduit exclusively from the outlet of the tank to the venturi mechanism.

According to further features in preferred embodiments of the invention described below, the at least one additional electrode located within the tank is constructed from at least one metal selected from the group consisting of copper, nickel, iron, aluminum, molybdenum, chromium, and titanium.

According to still further features in the described preferred embodiments the minerals to be removed are selected from the group of minerals consisting of calcium, magnesium, manganese, nickel, copper, potassium and aluminum.

According to further features in preferred embodiments of the invention described below, the tank contains a release valve for gases liberated by the electrolysis reaction which occurs when an electric current flows between the inner surface of the tank and the at least one additional electrode.

According to still further features in the described preferred embodiments the physical force employed to remove precipitated minerals is supplied by the cyclonic circulation of liquid in the tank.

According to further additional features in preferred embodiments of the invention described below, the strength of the cyclonic circulation within the tank is augmented by a flow of liquid through a venturi mechanism in a lower portion of the tank.

According to still further features in the described preferred embodiments there is an automated regulatory mechanism which controls the electric current applied to the supply of liquid, the circulation of liquid in the tank.

According to still further additional features in the described preferred the automated regulatory mechanism further controls the venturi mechanism, the drain valve and the one way valve.

According to further features in preferred embodiments of the invention described below, the steps of the method are applied cyclically so that the supply of liquid is reduced in mineral content as the supply is replenished.

### BRIEF DESCRIPTION OF THE DRAWINGS

The invention is herein described, by way of example only, with reference to the accompanying drawings, wherein:

FIG. 1 is a diagrammatic representation of a device for the automatic removal of minerals from a liquid supply with the tank of the device shown in longitudinal cross section.

FIG. 2 is a schematic representation showing the interface between an automatic control unit, which characterizes preferred embodiments of the device of the present invention, and other essential components of the device of the present invention.

### DESCRIPTION OF THE PREFERRED EMBODIMENTS

The present invention is of a device and method for the removal of minerals from a liquid supply, which can be used to prevent buildup of sediment in a system, including but not limited to, a cooling system, in which liquid flows. The invention is also of a method for removing mineral deposits from an inner surface of a tank serving as a reservoir for a system, including but not limited to, a cooling system, in which liquid flows.

Specifically, the present invention can be used to precipitate minerals from an aqueous solution by causing them to migrate towards, and adhere to, a cathodic surface, to weaken the bond of the precipitated minerals by reversing the polarity of the surface, thereby transforming it into an anodic surface, and to apply a physical force to the precipitated minerals so that they are compelled to enter a drain.

Additionally, the present invention can be used to remove sediment from an inner surface of a tank by weakening the bond of the precipitated minerals by applying an electric current to the surface, transforming it into an anodic surface, and applying a physical force to the precipitated minerals so that they are compelled to enter a drain.

For purposes of this specification and the accompanying claims, the terms “sediment”, “mineral deposit”, “precipitate”, and “precipitated mineral” and the plurals of these terms, are used interchangeably to refer to any inorganic salt found in an undissolved state in any container, including but not limited to a tank, whether adhering to a surface or circulating freely within liquid contained in the container.

For purposes of this specification and the accompanying claims, the term “conduit” refers to any pipe, tube, or channel through which a liquid, including but not limited to water, may flow.

For purposes of this specification and the accompanying claims, the term “liquid” refers primarily to water, but includes also any other fluid which might conceivably contain dissolved minerals which would precipitate over time. While the present invention is intended primarily for use with water, other liquids such as methanol might also be treated with the device and method of the present invention.

For purposes of this specification and the accompanying claims, the term “cyclonic flow” refers to a circular motion of liquid within a container, including but not limited to a downward spiral of liquid towards a drain in a container.

The principles and operation of a device and method for the removal of minerals from liquid according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

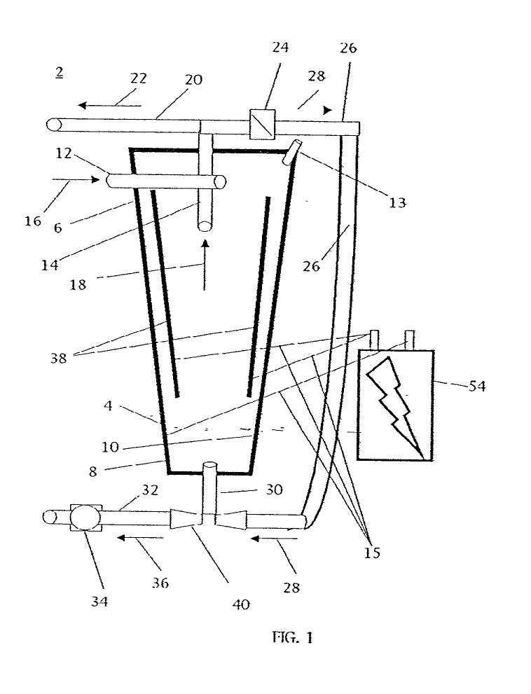

Referring now to the drawings, FIG. 1 illustrates device 2 of the present invention, which is used to practice the two methods of the present invention. The device includes a tank 4 having an upper portion 6, a lower portion 8 and an inner surface 10, inner surface 10 functioning as an electrode connected via conductive wiring 15 to an electric power supply 54. Tank 4 preferably has a height in the range of 700 to 1500 mm, most preferably approximately 1100 mm, and preferably has a width of 300 to 700 mm, most preferably approximately 500 mm. The upper portion of tank 4 has at least one inlet 12 for liquid and at least one outlet 14 to a system requiring liquid. At least one inlet 12 and at least one outlet 14 are arranged so that entry of liquid, as indicated by arrow 16, and exit of liquid, as indicated by arrow 18, from tank 4 create a cyclonic flow within tank 4. Lower portion 8 of tank 4 is connected to or integrally formed with a venturi mechanism 40 connected to a drain valve 34. At least one additional electrode 38 (two are pictured) is located within tank 4 a distance from inner surface 10 of tank 4 and connected via conductive wiring 15 to an electric power supply 54. The distance between electrode 38 and inner surface 10 is preferably 3 cm to 10 cm, most preferably approximately 5 cm. At least one additional electrode 38 is constructed from at least one metal selected from the group consisting of copper, nickel, iron, aluminum, molybdenum, chromium, and titanium. By way of example, additional electrode 38 has, in one preferred embodiment of the present invention, a length of 500 mm, a width of 80 mm and a thickness of 3 mm.

Liquid flows out of tank 4 via outlet 14 and pipe 20 to a system requiring liquid, for example a cooling tower, as indicated by arrows 18 and 22. According to some embodiments of the present invention, liquid may alternately exit via outlet 14 and conduit 26 which leads to venturi mechanism 40 which is in fluid communication with drainage opening 30 of tank 4 as indicated by arrows 18 and 28. According to these embodiments the path which liquid takes when exiting tank 4 is governed by one way valve 24. According to alternate embodiments of the present invention, conduit 26 is not connected to tank 4, but serves to bring liquid to the venturi mechanism from an alternate source. In either case, liquid passing through venturi mechanism 40 enters drainpipe 32 and passes though drain valve 34 as indicated by arrow 36.

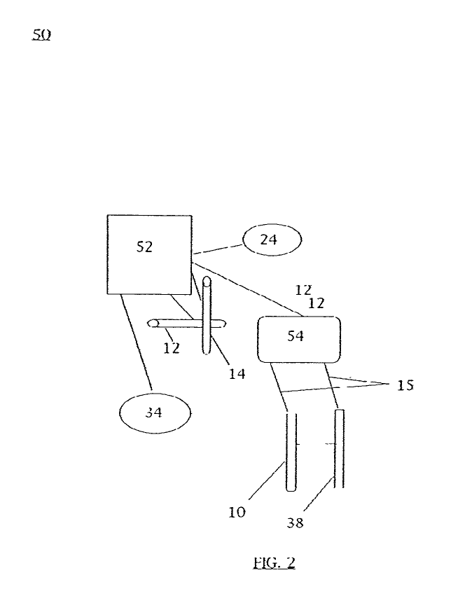

According to preferred embodiments of the present invention, function of the device of the present invention, and implementation of the method of the present invention, is under the control of an automated regulatory mechanism 50 (FIG. 2), which controls an electric current applied to electrodes 10 and 38 via an electric power source 54 which has reversible polarity, controls flow of liquid into tank 4 (not pictured) via inlet 12, controls flow of liquid out of tank 4 via outlet 14. According to some embodiments, regulatory mechanism 50 further controls the flow of liquid to venturi mechanism 40, further controls drain valve 34, and further controls one way valve 24. Automated regulatory mechanism 50 might include, but is not necessarily limited to a computerized CPU 52 with electronic interfaces attached. One ordinarily skilled in the art would be able to construct such a regulatory mechanism using existing technology. According to additional preferred embodiments of the present invention, control of parameters named herein is manual.

In order to precipitate minerals from liquid, an electric current is applied to the device so that the inner surface 10 of tank 4 becomes a cathode and at least one additional electrode 38 becomes a cathode. Potential difference between the electrodes is preferably between 3 and 24 volts, more preferably between 6 and 12 volts and most preferably approximately 9 volts. The applied electric current is preferably between 2 and 100 Amperes, more preferably between 3 and 20 Amperes, and most preferably approximately 5 Amperes. This causes a buildup of precipitated minerals at cathodic inner surface 10 of tank 4. Because the arrangement of inlet 12 and outlet 14 causes cyclonic circulation of liquid within tank 4, all liquid in tank 4 passes through the electric field between electrodes 38 and inner surface 10. This feature greatly improves the efficiency with which minerals are precipitated from liquid in tank 4. According to some embodiments, gases liberated during electrolysis are released via gas release valve 13. Minerals to be precipitated include, but are not necessarily limited to, those selected from the group of minerals consisting of oxides, hydroxides and salts of calcium, magnesium, manganese, nickel, copper, potassium and aluminum. In order to loosen the buildup of precipitate from inner surface 10 of tank 4, the polarity of the current is reversed so that inner surface 19 becomes the anode and additional electrodes 38 become the cathodes. According to preferred embodiments of the present invention this current reversal occurs with a frequency between once every 10 minutes and once every hour, more preferably with a frequency between once every 20 minutes and once every 40 minutes, most preferably with a frequency of approximately once every 30 minutes. It will be appreciated that this frequency is a function of the total amount of minerals present in tank 4, which depends upon both the volume of tank 4 and the concentration of minerals contained therein. The period of time for current reversal is preferably of 30 seconds to 5 minutes duration, more preferably of 1 minutes to 3 minutes duration, most preferably of approximately 2 minutes duration.

In order to remove the loosened mineral precipitate from the electrodic inner surface 10 of tank 4, a physical force is applied. In preferred embodiments of the present invention, this force takes the form of a strong downward spiraling hydrocyclone. Such a hydrocyclone is created by directing a stream of liquid through venturi mechanism 40 in fluid communication with drainage opening 30 of tank 4. This is accomplished by opening drain valve 34. Flow of liquid through drain valve 34 causes a flow in the direction indicated by arrow 36 which pulls liquid from venturi mechanism 40 and conduit 26, opening one way valve 24. The stream of liquid thus created through venturi mechanism 40 creates a downward suction in drainage opening 30, which pulls liquid downward from tank 4. The downward spiraling hydrocyclone thus created causes liquid in tank 4 to exert a significant shear force along inner surfaces 10 which dislodges the loosened precipitate, allowing it to move towards, and through drainage opening 30. The precipitate subsequently joins the stream of liquid flowing through venturi mechanism 40, proceeds through drain valve 34 to a drain (not pictured). According to preferred embodiments of the present invention, drain valve 34 is opened for a period of approximately 15 seconds at the end of the period of electric current reversal described hereinabove.

According to alternate preferred embodiments of the present invention, mineral deposits on an inner surface 10 of tank 4 are loosened by applying an electric current for a period of time, the current having inner surface 10 as its anode and at least one additional electrode 38 (two are pictured) within tank 4 as a cathode. Mineral deposits from inner surface 10 of tank 4 are removed by means of a hydrocyclone created by a flow of liquid through venturi mechanism 40 in fluid communication with tank 4 via drain opening 30. This same hydrocyclone subsequently causes mineral deposits to exit tank 4 via drain opening 30.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A device for the automatic removal of minerals from a liquid supply, the device comprising:
(a) a tank having an inner surface functioning as an electrode, a lower portion, and an upper portion having:
(i) at least one inlet for the liquid, and
(ii) at least one outlet for the liquid,
said at least one inlet and at least one outlet being arranged such that entry and exit of liquid from said tank create a cyclonic flow;
(b) at least one additional electrode, located within said tank, such that said cyclonic flow of liquid passes between said at least one additional electrode and said inner surface of said tank; and
(c) a mechanism for creating an electric current flowing between said at least one additional electrode and said inner surface of said tank.

2. The device of claim 1 further comprising:
(d) a venturi mechanism, in communication with said lower portion of said tank; and
(e) a drain valve, in communication with said venturi mechanism.

3. The device of claim 1, further comprising:
(d) a regulatory mechanism for controlling said electric current flowing between said electrodes, flow of liquid into said tank via said inlet, and flow of liquid out of said tank via said outlet

4. The device of claim 2, further comprising:
(e) a regulatory mechanism for controlling said electric current flowing between said electrodes, flow of liquid into said tank via said inlet, flow of liquid out of said tank via said outlet, said venturi mechanism and said drain valve.

5. The device of claim 1, wherein said mechanism for creating an electric current produces an electric current between 2 and 100 Amperes.

6. The device of claim 1, wherein said mechanism for creating an electric current produces an electric current between 3 and 20 Amperes.

7. The device of claim 1, wherein said mechanism for creating an electric current produces an electric current of approximately 5 Amperes.

8. The device of claim 1, wherein said mechanism for creating an electric current is operative to apply a potential difference of between 3 and 24 volts between said inner surface and said additional electrode.

9. The device of claim 1, wherein said mechanism for creating an electric current is operative to apply a potential difference between 6 and 12 volts between said inner surface and said additional electrode.

10. The device of claim 1, wherein said mechanism for creating an electric current is operative to apply a potential difference of approximately 9 volts between said inner surface and said additional electrode.

11. The device of claim 2, further comprising:
(f) a liquid conduit connecting said outlet from said tank to said venturi mechanism.

12. The device of claim 11, further comprising:
(g) a one-way valve which allows said liquid to flow in said conduit exclusively from said outlet to said venturi mechanism.

13. The device of claim 1, wherein said at least one additional electrode includes at least one metal selected from the group consisting of copper, nickel, iron, aluminum, molybdenum, chromium, and titanium.

14. The device of claim 1, further comprising:
(d) a release valve for gases liberated by the electrolysis reaction which occurs when an electric current flows between said inner surface of said tank and said at least one additional electrode.

15. A method for the removal of minerals from a liquid in a tank, the method comprising the steps of:
(a) causing the liquid to circulate cyclonically within the tank;
(b) applying an electric current to the liquid circulating in the tank in said cyclonic fashion, thereby causing the minerals to precipitate on an inner surface of the tank so that a bond is formed between the minerals and said inner surface; and
(c) reversing a polarity of said electric current, thereby weakening the bond of said precipitated minerals to said inner surface of said tank.

16. The method of claim 15, further comprising the steps of:
(d) applying a physical force to said precipitated minerals, thereby freeing said precipitated minerals from said inner surface of said tank;
(e) removing said precipitated minerals from said tank via a drain.

17. The method of claim 15, wherein said physical force is supplied by said cyclonic circulation of the liquid in the tank.

18. The method of claim 15, further comprising the steps of:
(d) providing a venturi mechanism in a lower portion of the tank; and
(e) causing the liquid to flow through said venturi mechanism, thereby augmenting said cyclonic flow.

19. The method of claim 15, wherein said steps are applied cyclically.

20. The method of claim 15, wherein said reversing of said polarity of said electric current is effected for a time greater than 30 seconds and less than 5 minutes.

21. The method of claim 15, wherein said reversing of said polarity of said electric current is effected for a time greater than 1 minute and less than 3 minutes.

22. The method of claim 15, wherein said reversing of said polarity of said electric current is effected for approximately 2 minutes.

23. The method of claim 19, wherein said cyclical application of steps is effected at least once every 24 hours, but less often than every 5 minutes.

24. The method of claim 19, wherein said cyclical application of steps is effected at least once every 12 hours, but less often than every 15 minutes.

25. The method of claim 19, wherein said cyclical application of steps is effected at least once every 8 hours, but less often than every 20 minutes.

26. The method of claim 19, wherein said cyclical application of steps is effected every 30 minutes.

27. The method of claim 15, wherein said electric current is between 2 and 100 Amperes.

28. The method of claim 15, wherein said electric current is between 3 and 20 Amperes.

29. The method of claim 15, wherein said electric current is approximately 5 Amperes.

30. The method of claim 15, wherein said electric current is applied by steps including:
(i) introducing an additional electrode to the tank, and
(ii) imposing a potential difference of from 3 volts to 24 volts between said inner surface of the tank and said additional electrode.

31. The method of claim 15, wherein said electric current is applied by steps including:
(i) introducing an additional electrode to the tank, and
(ii) imposing a potential difference of from 6 volts to 12 volts between said inner surface of the tank and said additional electrode.

32. The method of claim 15, wherein said electric current is applied by steps including:
(i) introducing an additional electrode to the tank, and
(ii) imposing a potential difference of approximately 9 volts between said inner surface of the tank and said additional electrode.

33. A method for removing mineral deposits from an inner surface of a tank, the method comprising the steps of:
(a) providing at least one cathode within the tank;
(b) causing an electric current to flow between said at least one cathode and the inner surface of the tank, the inner surface of the tank then serving as an anode, thereby loosening the mineral deposits from the inner surface; and
(c) removing said mineral deposits from said inner surface of said tank by means of a physical force.

34. The method of claim 33, wherein said physical force is supplied by a cyclonic flow within the tank.
